(19) United States
(12) Patent Application Publication
(10) Pub. No.: US 2019/0322159 A1
(43) Pub. Date: Oct. 24, 2019

(54) VEHICULAR AIR CONDITIONING SYSTEM

(71) Applicant: Hanon Systems, Daejeon (KR)

(72) Inventors: Doo Hoon KIM, Daejeon (KR); Hyeon Gyu KIM, Daejeon (KR); Kyung Ju AN, Daejeon (KR); Sang Jun YOO, Daejeon (KR); Joong Man HAN, Daejeon (KR)

(21) Appl. No.: 16/386,541

(22) Filed: Apr. 17, 2019

(30) Foreign Application Priority Data
Apr. 19, 2018 (KR) 10-2018-0045337
Mar. 28, 2019 (KR) 10-2019-0035864

(51) Int. Cl. B60H 1/32; B60H 1/00; B60L 58/26

(52) U.S. Cl. CPC B60H 1/3216; B60H 1/3208; B60H 2001/3272; B60L 58/26; B60H 1/00328

(57) ABSTRACT

A vehicular air conditioning system includes: a refrigerant circulation line provided with a compressor, an outdoor heat exchanger, an expansion valve and an indoor heat exchanger; and a control unit configured to variably control a rotation speed of the compressor depending on a refrigerant discharge pressure and a refrigerant discharge temperature on an outlet side of the compressor.

### CROSS-REFERENCE TO RELATED PATENT APPLICATIONS

This application claims priority of Korean Patent Application Nos. 10-2018-0045337 filed Apr. 19, 2018 and 10-2019-0035864 filed Mar. 28, 2019, which are hereby incorporated herein by reference in their entirety.

### TECHNICAL FIELD

The present invention relates to a vehicular air conditioning system and, more particularly, to a vehicular air conditioning system capable of improving a compressor control scheme to prevent an excessive increase in a rotation speed of a compressor without deteriorating the passenger compartment cooling performance and to prevent degradation, damage or breakage of a compressor, refrigerant pipes, sealing components and the like, which may be caused by an excessive increase in a rotation speed of a compressor.

### BACKGROUND ART

A hybrid vehicle is a vehicle that uses an electric motor and an internal combustion engine in combination. When the hybrid vehicle is running at a high load, for example, when the hybrid vehicle is running at a high speed or on an uphill, the hybrid vehicle comes into an engine driven mode in which an engine is used.

Conversely, the hybrid vehicle is running at a low load, for example, when the hybrid vehicle is running at a low speed or stopped, the hybrid vehicle comes into a motor driven mode in which an electric motor is used.

Such a hybrid vehicle (hereinafter generally referred to as “vehicle”) is equipped with an air conditioning system for cooling and heating a passenger compartment.

The air conditioning system is of a heat pump type and is used for a cooling or heating purpose while being controlled in an air conditioner mode or a heat pump mode according to a flow direction of a refrigerant in a refrigerant circulation line.

Particularly, in the air conditioner mode, the refrigerant is circulated while forming an air conditioner cycle, cold air having a low temperature is generated through such circulation of the refrigerant, and a passenger compartment is cooled by the cold air thus generated.

In the heat pump mode, the refrigerant is circulated while forming a heat pump cycle, the high-temperature heat is generated through such circulation of the refrigerant, and the passenger compartment is heated by the heat thus generated.

However, such a conventional air conditioning system has a disadvantage in that the rotation speed of the compressor is excessively increased when the cooling load suddenly increases. Thus, the refrigerant pressure and the refrigerant temperature on the outlet side of the compressor are increased, which may pose a problem of causing degradation and breakage of a compressor, refrigerant pipes, sealing components and the like.

Particularly, when a water-cooled battery cooling device using the refrigerant of the air conditioning system is operated during the operation of the air conditioning system, or when the engine is operated so that the heat of the engine acts on an outdoor heat exchanger for cooling the refrigerant of the air conditioning system, the cooling load of the air conditioning system is further increased and the heat exchange efficiency of the outdoor heat exchanger is further lowered. The rotation speed of the compressor is excessively increased due to the increase in the cooling load and the decrease in the heat exchange efficiency of the outdoor heat exchanger.

In addition, there is a problem that the refrigerant pressure and the refrigerant temperature on the outlet side of the compressor are excessively increased due to the excessive increase in the rotation speed of the compressor. Thus, the degradation or breakage of a compressor, refrigerant pipes, sealing components and the like is further intensified and, hence, the durability of the air conditioning system is remarkably lowered.

### SUMMARY

In view of the aforementioned problems inherent in the related art, it is an object of the present invention to provide a vehicular air conditioning system capable of improving a compressor control scheme to prevent an excessive increase in a rotation speed of a compressor without deteriorating the passenger compartment cooling performance even when the cooling load is increased and the heat exchange efficiency of an outdoor heat exchanger is lowered due to various factors.

Another object of the present invention is to provide a vehicular air conditioning system capable of preventing degradation, damage or breakage of a compressor, refrigerant pipes, sealing components and the like, which may be caused by an excessive increase in a rotation speed of a compressor.

A further object of the present invention is to provide a vehicular air conditioning system capable of exhibiting enhanced durability.

According to one aspect of the present invention, there is provided a vehicular air conditioning system, including: a refrigerant circulation line provided with a compressor, an outdoor heat exchanger, an expansion valve and an indoor heat exchanger; and a control unit configured to variably control a rotation speed of the compressor depending on a refrigerant discharge pressure and a refrigerant discharge temperature on an outlet side of the compressor.

In the system, the control unit may be configured to reduce the rotation speed of the compressor step by step just as much as a predetermined rotation speed value until the refrigerant discharge pressure is increased to a predetermined reference pressure or until the refrigerant discharge temperature is increased to a predetermined reference temperature.

In the system, the control unit may be configured to turn off the compressor when the refrigerant discharge pressure reaches the predetermined reference pressure or when the refrigerant discharge temperature reaches the predetermined reference temperature.

In the system, the control unit may be configured to primarily reduce the rotation speed of the compressor just as much as a predetermined rotation speed value when the refrigerant discharge pressure is equal to or higher than a predetermined first reference pressure or when the refrigerant discharge temperature is equal to or higher than a predetermined first reference temperature, the control unit may be configured to secondarily reduce the rotation speed of the compressor just as much as a predetermined rotation speed value when the refrigerant discharge pressure becomes equal to or higher than a second reference pressure higher than the first reference pressure or when the refrigerant discharge temperature becomes equal to or higher than a second reference temperature which is higher than the first reference temperature, and the control unit may be configured to turn off the compressor when the refrigerant discharge pressure becomes equal to or higher than a third reference pressure which is higher than the second reference pressure or when the refrigerant discharge temperature becomes equal to or higher than a third reference temperature which is higher than the second reference temperature.

The system may further include: a water-cooled battery cooling device configured to cool a battery using a refrigerant in the refrigerant circulation line, wherein the control unit may be configured to prevent an excessive increase in the rotation speed of the compressor by variably controlling the rotation speed of the compressor depending on the refrigerant discharge pressure and the refrigerant discharge temperature when a load of the compressor is increased due to an operation of the water-cooled battery cooling device.

According to the vehicular air conditioning system of the present invention, when the rotation speed of the compressor is excessive, the rotation speed of the compressor is controlled step by step until the refrigerant discharge pressure and the refrigerant discharge temperature of the compressor become stable. Therefore, it is possible to prevent an excessive increase in the refrigerant discharge pressure and the refrigerant discharge temperature of the compressor, which may be caused by the excessively high rotation speed of the compressor.

Furthermore, it is possible to prevent degradation, damage or breakage of the compressor, the refrigerant pipes, the sealing components and the like, which may be caused by the excessive increase in the rotation speed of the compressor.

Moreover, it is possible to improve the durability of the air conditioning system.

In addition, when the rotation speed of the compressor is excessively lowered, the rotation speed of the compressor is increased to an optimum level. Therefore, it is possible to prevent an excessive increase in the rotation speed of the compressor without deteriorating the passenger compartment cooling performance. This makes it possible to prevent degradation, damage or breakage of the compressor, the refrigerant pipes, the sealing components and the like without deteriorating the passenger compartment cooling performance.

### BRIEF DESCRIPTION OF THE DRAWINGS

FIG. 1 is a view showing a vehicular air conditioning system according to a first embodiment of the present invention.

FIG. 2A is a graph showing a change in a rotation speed (RPM) of a compressor and a change in a refrigerant temperature and a refrigerant pressure on the outlet side of the compressor during the operation of the air conditioning system in the vehicular air conditioning system according to the present invention, and FIG. 2B is a graph showing a change in a rotation speed (RPM) of a compressor and a change in a refrigerant temperature and a refrigerant pressure on the outlet side of the compressor during the operation of the air conditioning system in the conventional vehicular air conditioning system.

FIGS. 3 and 4 are flow charts showing an operation example of the vehicular air conditioning system according to the present invention.

FIG. 5 is a view showing a vehicular air conditioning system according to a second embodiment of the present invention.

### DETAILED DESCRIPTION

Preferred embodiments of a vehicular air conditioning system according to the present invention will now be described in detail with reference to the accompanying drawings.

### First Embodiment

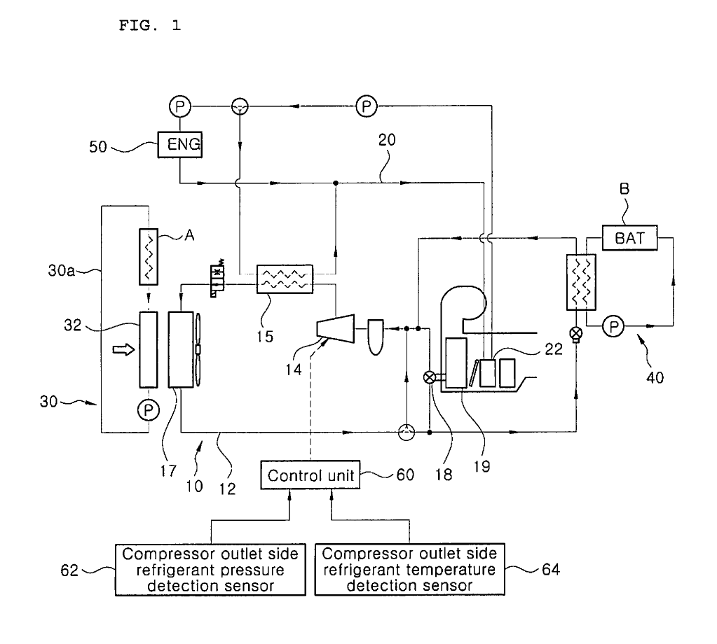

Prior to describing features of a vehicular air conditioning system according to the present invention, a vehicular air conditioning system 10 will be briefly described with reference to FIG. 1.

The vehicular air conditioning system 10 is of a heat pump type and is provided with a refrigerant circulation line 12. The refrigerant circulation line 12 includes a compressor 14, a water-cooled heat exchanger 15, a heat pump mode expansion valve 16, an outdoor heat exchanger 17, an air conditioner mode expansion valve 18 and an indoor heat exchanger 19.

When a passenger compartment is cooled, the refrigerant circulation line 12 is controlled in an air conditioner mode to open the heat pump mode expansion valve 16.

Thus, the refrigerant is circulated without going through the heat pump mode expansion valve 16. A cold air having a low temperature is generated by such circulation of the refrigerant. The passenger compartment is cooled by the cold air thus generated.

When the passenger compartment is heated, the refrigerant circulation line 12 is controlled in a heat pump mode to turn on the heat pump mode expansion valve 16.

Thus, the refrigerant is circulated through the heat pump mode expansion valve 16. Heat having a high temperature is generated in the water-cooled heat exchanger 15 by such circulation of the refrigerant and is transferred to a heater core side cooling water circulation line 20. The high-temperature heat is radiated into the passenger compartment through a heater core 22 to heat the passenger compartment.

A radiator 32 of a water-cooled electric component module cooling device 30 is disposed in parallel with the outdoor heat exchanger 17 of the vehicular air conditioning system 10.

The radiator 32 of the water-cooled electric component module cooling device 30 is disposed on the front side of the outdoor heat exchanger 17 based on an air flow direction so that the cooling water flowing along an electric component module side cooling water circulation line 30a can exchange heat with ambient air. Specifically, the cooling water in the electric component module side cooling water circulation line 30a which has absorbed the waste heat of an electric component module A is caused to exchange heat with the ambient air, whereby the waste heat of the electric component module A is dissipated.

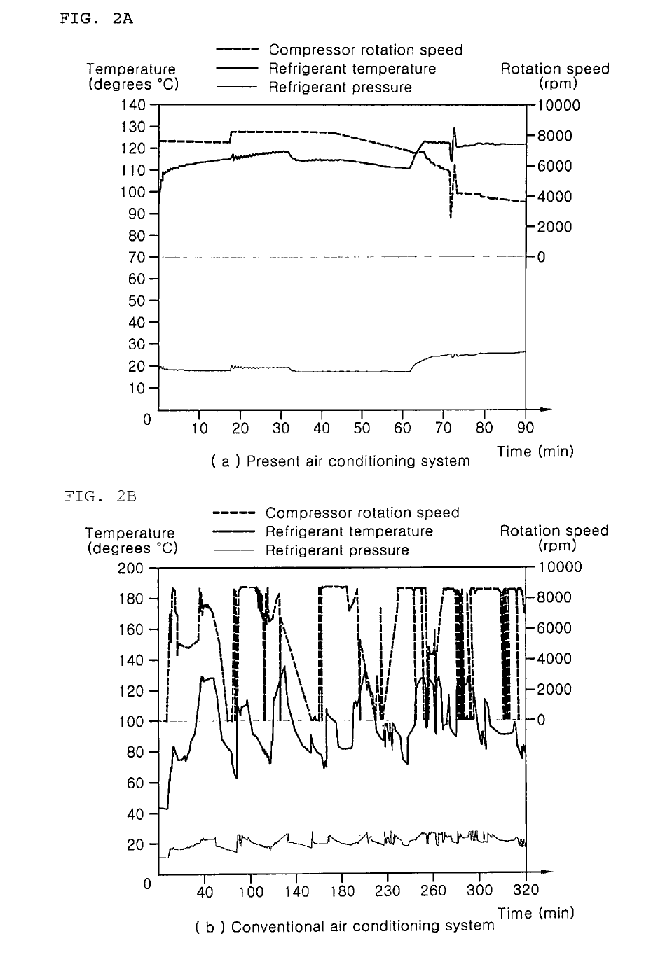

Next, the features of the vehicular air conditioning system according to the present invention will be described in detail with reference to FIGS. 1 and 2.

Referring first to FIG. 1, the vehicular air conditioning system according to the present invention includes a compressor outlet side refrigerant pressure detection sensor 62 installed on an outlet side of the compressor 14, a compressor outlet side refrigerant temperature detection sensor 64 installed on the outlet side of the compressor 14, and a control unit 60 configured to variably control a rotation speed of the compressor 14 according to a refrigerant pressure and a refrigerant temperature on the outlet side of the compressor 14 inputted from the compressor outlet side refrigerant pressure detection sensor 62 and the compressor outlet side refrigerant temperature detection sensor 64.

The control unit 60 is provided with a microprocessor. When a refrigerant discharge pressure and a refrigerant discharge temperature are inputted from the compressor outlet side refrigerant pressure detection sensor 62 and the compressor outlet side refrigerant temperature detection sensor 64, the control unit 60 compares the refrigerant discharge pressure and the refrigerant discharge temperature with a pre-stored reference pressure and a pre-stored reference temperature, respectively.

Specifically, the control unit 60 determines whether the refrigerant discharge pressure inputted from the compressor outlet side refrigerant pressure detection sensor 62 is equal to or higher than a pre-stored first reference pressure P1 or whether the refrigerant discharge temperature inputted from the compressor outlet side refrigerant temperature detection sensor 64 is equal to or higher than a pre-stored first reference temperature T1.

If the result of comparison indicates that the refrigerant discharge pressure is equal to or higher than the first reference pressure P1 or the refrigerant discharge temperature is equal to or higher than the first reference temperature T1, the control unit 60 recognizes that the cooling load is increased by a specific cause and, hence, the rotation speed of the compressor 14 is excessively increased.

Specifically, if a water-cooled battery cooling device 40 for cooling a battery B is operated in a battery charging mode, or if an engine 50 is operated so that the heat of the engine 50 acts on the outdoor heat exchanger 17 of the vehicular air conditioning system, the cooling load is sharply increased. In this case, the control unit 60 recognizes that the rotation speed of the compressor 14 is excessively increased. When such recognition is made, the control unit 60 determines that it is necessary to reduce the rotation speed of the compressor 14.

When such determination is made, the control unit 60 enters a primary compressor rotation speed reduction mode to forcibly reduce the rotation speed of the compressor 14 just as much as a predetermined rotation speed value.

Therefore, it is possible to prevent an excessive increase in the rotation speed of the compressor 14. This makes it possible to prevent degradation, damage or breakage of the compressor 14, the refrigerant pipes, the sealing components and the like, which may be caused by an excessive increase in the rotation speed of the compressor 14.

Even after reducing the rotation speed of the compressor 14, the control unit 60 continues to monitor the refrigerant discharge pressure inputted from the compressor outlet side refrigerant pressure detection sensor 62 and the refrigerant discharge temperature inputted from the compressor outlet side refrigerant temperature detection sensor 64.

If the refrigerant discharge pressure inputted from the compressor outlet side refrigerant pressure detection sensor 62 is equal to or higher than a second reference pressure P2 higher than the first reference pressure P1, or if the refrigerant discharge temperature inputted from the compressor outlet side refrigerant temperature detection sensor 64 is higher than a second reference temperature T2 which is higher than the first reference temperature T1, the control unit 60 recognizes that the rotation speed of the compressor 14 is still excessively high. Based on such recognition, the control unit 60 determines that it is necessary to further reduce the rotation speed of the compressor 14.

When such determination is made, the control unit 60 enters a secondary compressor rotation speed reduction mode to further reduce the rotation speed of the compressor 14 just as much as a predetermined rotation speed value.

Therefore, it is possible to prevent an excessive increase in the refrigerant discharge pressure and the refrigerant discharge temperature, which may be caused by the excessively high rotation speed of the compressor 14. This makes it possible to further prevent degradation, damage or breakage of the compressor 14, the refrigerant pipes, the sealing components and the like, which may be caused by an excessive increase in the refrigerant discharge pressure and the refrigerant discharge temperature of the compressor 14.

Even after secondarily reducing the rotation speed of the compressor 14, the control unit 60 continues to monitor the refrigerant discharge pressure and the refrigerant discharge temperature.

If the result of monitoring indicates that the refrigerant discharge pressure is equal to or higher than a third reference pressure P3 which is higher than the second reference pressure P2, or if the refrigerant discharge temperature is equal to or higher than a third reference temperature T3 which is higher than the second reference temperature T2, the control unit 60 determines that the rotation speed of the compressor 14 is still excessively high and the refrigerant discharge pressure and the refrigerant discharge temperature of the compressor 14 are still high despite the reduction of the rotation speed of the compressor 14.

When such determination is made, the control unit 60 enters a compressor stop mode to turn off the compressor 14, thereby stopping the compressor 14. This makes it possible to reliably prevent an excessive increase in the refrigerant discharge pressure and the refrigerant discharge temperature, which may be caused by the excessively high rotation speed of the compressor 14. As a result, it is possible to reliably prevent degradation, damage or breakage of the compressor 14, the refrigerant pipes, the sealing components and the like, which may be caused by an excessive increase in the refrigerant discharge pressure and the refrigerant discharge temperature of the compressor 14.

As a result, the control unit 60 reduces the rotation speed of the compressor 14 step by step until the refrigerant discharge pressure reaches the third reference pressure P3 or until the refrigerant discharge temperature reaches the third reference temperature T3.

Therefore, as shown in FIG. 2A, the excessive increase in the refrigerant discharge pressure and the refrigerant discharge temperature of the compressor 14 caused by the excessively high rotation speed of the compressor 14 is suppressed step by step. Thus, the compressor 14, the refrigerant pipes, the sealing components and the like are primarily protected from the excessively high refrigerant discharge pressure and the excessively high refrigerant discharge temperature.

Then, if the refrigerant discharge pressure reaches the third reference pressure P3, or if the refrigerant discharge temperature reaches the third reference temperature T3, the compressor 14 is completely turned off. This makes it possible to reliably prevent an excessive increase in the refrigerant discharge pressure and the refrigerant discharge temperature, which may be caused by the excessively high rotation speed of the compressor 14.

Specifically, it is possible to reliably suppress an excessive increase in the refrigerant discharge pressure and the refrigerant discharge temperature on the outlet side of the compressor 14, which may be caused by the excessive increase in the rotation speed of the compressor 14 as in the conventional vehicular air conditioning system shown in FIG. 2B. Thus, the compressor 14, the refrigerant pipes, the sealing components and the like are secondarily protected from the excessively high refrigerant discharge pressure and the excessively high refrigerant discharge temperature.

After entering the primary compressor rotation speed reduction mode or the secondary compressor rotation speed reduction mode to reduce the rotation speed of the compressor 14, the control unit 60 continues to monitor the refrigerant discharge pressure and the refrigerant discharge temperature.

If at least one of a condition that the refrigerant discharge pressure is lower than the first reference pressure P1 and a condition that the refrigerant discharge temperature is lower than the first reference temperature T1 is satisfied and if both a condition that the refrigerant discharge pressure is equal to or higher than a fourth reference pressure P4 which is lower than the first reference pressure P1 and a condition that the refrigerant discharge temperature is equal to or higher than a fourth reference temperature T4 which is lower than the first reference temperature T1 are satisfied, the control unit 60 determines that the rotation speed of the compressor 14 is stable and the refrigerant discharge pressure and the refrigerant discharge temperature are also stable.

When such determination is made, the control unit 60 enters a compressor rotation speed maintaining mode to maintain the rotation speed of the compressor 14 as it is.

If the refrigerant discharge pressure becomes equal to or lower than a fifth reference pressure P5 which is lower than the fourth reference pressure P4 in the primary compressor rotation speed reduction mode, the secondary compressor rotation speed reduction mode or the compressor rotation speed maintaining mode, or if the refrigerant discharge temperature becomes equal to or lower than a fifth reference temperature T5 which is lower than the fourth reference temperature T4 in the primary compressor rotation speed reduction mode, the secondary compressor rotation speed reduction mode or the compressor rotation speed maintaining mode, the control unit 60 determines that the rotation speed of the compressor 14 is excessively low and the passenger compartment cooling performance is lowered.

When such determination is made, the control unit 60 enters a compressor rotation speed increasing mode to increase the rotation speed of the compressor 14 just as much as a predetermined rotation speed value. Thus, the refrigerant discharge pressure is increased to enhance the passenger compartment cooling performance.

Next, an example of the operation of the vehicular air conditioning system having the configuration described above will be described with reference to FIGS. 1, 3 and 4.

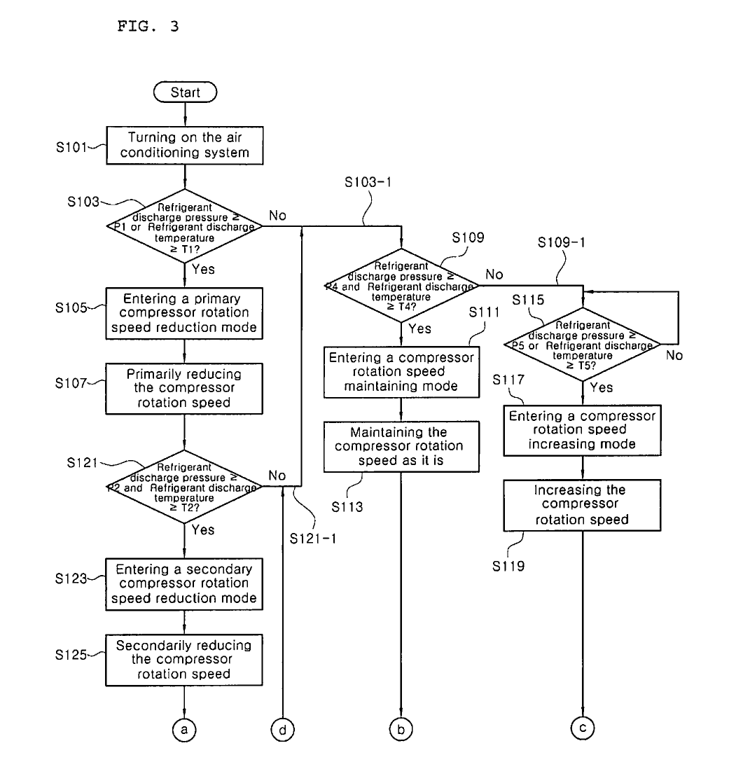

Referring first to FIG. 3, the vehicular air conditioning system 10 is turned on (S101). In this state, the control unit 60 determines whether the refrigerant discharge pressure of the compressor 14 is equal to or higher than the first reference pressure P1 or whether the refrigerant discharge temperature is equal to or higher than the first reference temperature T1 (S103).

If the result of determination indicates that the refrigerant discharge pressure is equal to or higher than the first reference pressure P1 or the refrigerant discharge temperature is equal to or higher than the first reference temperature T1, the control unit 60 recognizes that the rotation speed of the compressor 14 is excessively high. Based on such recognition, the control unit 60 enters the primary compressor rotation speed reduction mode (S105).

The control unit 60 which has entered the primary compressor rotation speed reduction mode forcibly reduces the rotation speed of the compressor 14 just as much as a predetermined rotation speed value (S107).

Therefore, it is possible to prevent an excessive increase in the rotation speed of the compressor 14. This makes it possible to prevent degradation, damage or breakage of the compressor 14, the refrigerant pipes, the sealing components and the like, which may be caused by an excessive increase in the rotation speed of the compressor 14.

If it is determined in step S103 that the refrigerant discharge pressure is not equal to or higher than the first reference pressure P1 or the refrigerant discharge temperature is not equal to or higher than the first reference temperature T1 (S103-1), namely if it is determined in step S103 that the refrigerant discharge pressure is lower than the first reference pressure P1 or the refrigerant discharge temperature is lower than the first reference temperature T1, the control unit 60 determines whether the refrigerant discharge pressure is equal to or higher than the fourth reference pressure P4 which is lower than the first reference pressure P1 and whether the refrigerant discharge temperature is equal to or higher than the fourth reference temperature T4 which is lower than the first reference temperature T1 (S109).

That is to say, the control unit 60 determines whether both a condition that the refrigerant discharge pressure is a value between the first reference pressure P1 and the fourth reference pressure P4 and a condition that the refrigerant discharge temperature is a value between the first reference temperature T1 and the fourth reference temperature T4 are satisfied.

If it is determined that the refrigerant discharge pressure is equal to or higher than the fourth reference pressure P4 and the refrigerant discharge temperature is equal to or higher than the fourth reference temperature T4, the control unit 60 recognizes that the rotation speed of the compressor 14 is stable and the refrigerant discharge pressure and the refrigerant discharge temperature are also stable.

When such recognition is made, the control unit 60 enters a compressor rotation speed maintaining mode (S111) to maintain the rotation speed of the compressor 14 as it is (S113).

If it is determined that the refrigerant discharge pressure is not equal to or higher than the fourth reference pressure P4 and the refrigerant discharge temperature is not equal to or higher than the fourth reference temperature T4 (S109-1), namely if it is determined that the refrigerant discharge pressure is lower than the fourth reference pressure P4 and the refrigerant discharge temperature is lower than the fourth reference temperature T4, the control unit 60 determines whether the refrigerant discharge pressure becomes equal to or lower than the fifth reference pressure P5 which is lower than the fourth reference pressure P4 or whether the refrigerant discharge temperature becomes equal to or higher than the fifth reference temperature T5 which is lower than the fourth reference temperature T4 (S115).

If the result of determination indicates that the refrigerant discharge pressure becomes equal to or lower than the fifth reference pressure P5 or that the refrigerant discharge temperature becomes equal to or higher than the fifth reference temperature T5, the control unit 60 recognizes that the rotation speed of the compressor 14 is excessively low and the passenger compartment cooling performance is lowered.

When such determination is made, the control unit 60 enters the compressor rotation speed increasing mode (S115) to increase the rotation speed of the compressor 14 just as much as a predetermined rotation speed value (S117). Thus, the refrigerant discharge pressure is increased to enhance the passenger compartment cooling performance.

Referring again to FIG. 3, the control unit 60 primarily reduces the rotation speed of the compressor 14 (S107). In this state, the control unit 60 determines whether the refrigerant discharge pressure is equal to or higher than the second reference pressure P2 which is higher than the first reference pressure P1 or whether the refrigerant discharge temperature is equal to or higher than the second reference temperature T2 which is higher than the first reference temperature T1 (S121).

If the result of determination indicates that the refrigerant discharge pressure is equal to or higher than the second reference pressure P2 or that the refrigerant discharge temperature is equal to or higher than the second reference temperature T2, the control unit 60 recognizes that the rotation speed of the compressor 14 is still excessively high. Based on such recognition, the control unit 60 enters the secondary compressor rotation speed reduction mode (S123).

The control unit 60 which has entered the secondary compressor rotation speed reduction mode further reduces the rotation speed of the compressor 14 just as much as a predetermined rotation speed value (S125).

Therefore, it is possible to prevent an excessive increase in the refrigerant discharge pressure and the refrigerant discharge temperature, which may be caused by the excessively high rotation speed of the compressor 14. This makes it possible to prevent degradation, damage or breakage of the compressor 14, the refrigerant pipes, the sealing components and the like, which may be caused by an excessive increase in the refrigerant discharge pressure and the refrigerant discharge temperature of the compressor 14.

If it is determined in step S121 that the refrigerant discharge pressure is not equal to or higher than the second reference pressure P2 or that the refrigerant discharge temperature is not equal to or higher than the second reference temperature T2 (S121-1), namely if it is determined in step S121 that the refrigerant discharge pressure is lower than the second reference pressure P2 or that the refrigerant discharge temperature is lower than the second reference temperature T2, the control unit 60 performs steps S109, S111, S113, S115, S117 and S119.

Therefore, depending on the refrigerant discharge pressure and the refrigerant discharge temperature, the rotation speed of the compressor 14 may be maintained as it is or may be increased just as much as a predetermined rotation speed value.

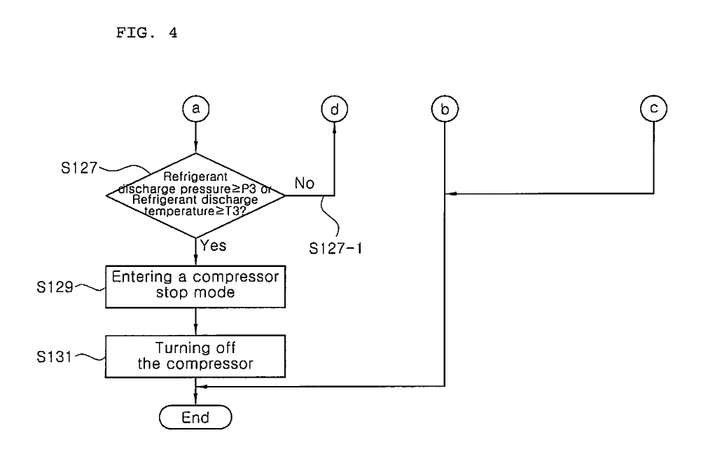

Referring to FIGS. 3 and 4, the rotation speed of the compressor 14 is secondarily reduced (S125). In this state, the control unit 60 determines whether the refrigerant discharge pressure is equal to or higher than the third reference pressure P3 which is higher than the second reference pressure P2 or whether the refrigerant discharge temperature is equal to or higher than the third reference temperature T3 which is higher than the second reference temperature T2 (S127).

If the result of determination indicates that the refrigerant discharge pressure is equal to or higher than the third reference pressure P3 or that the refrigerant discharge temperature is equal to or higher than the third reference temperature T3, the control unit 60 recognizes that the rotation speed of the compressor 14 is still excessively high despite the reduction of the rotation speed of the compressor 14.

When such determination is made, the control unit 60 enters the compressor stop mode (S129) to turn off the compressor 14 (S131), thereby stopping the compressor 14. This makes it possible to reliably prevent an excessive increase in the rotation speed of the compressor 14 and a resultant excessive increase in the refrigerant discharge pressure and the refrigerant discharge temperature. As a result, it is possible to reliably prevent degradation, damage or breakage of the compressor 14, the refrigerant pipes, the sealing components and the like, which may be caused by an excessive increase in the refrigerant discharge pressure and the refrigerant discharge temperature.

If it is determined in step S127 that the refrigerant discharge pressure is not equal to or higher than the third reference pressure P3 or that the refrigerant discharge temperature is not equal to or higher than the third reference temperature T3 (S127-1), namely if it is determined in step S127 that the refrigerant discharge pressure is lower than the third reference pressure P3 or that the refrigerant discharge temperature is lower than the third reference temperature T3, the control unit 60 performs steps S109, S111, S113, S115, S117 and S119.

Therefore, depending on the refrigerant discharge pressure and the refrigerant discharge temperature, the rotation speed of the compressor 14 may be maintained as it is or may be increased just as much as a predetermined rotation speed value.

### Second Embodiment

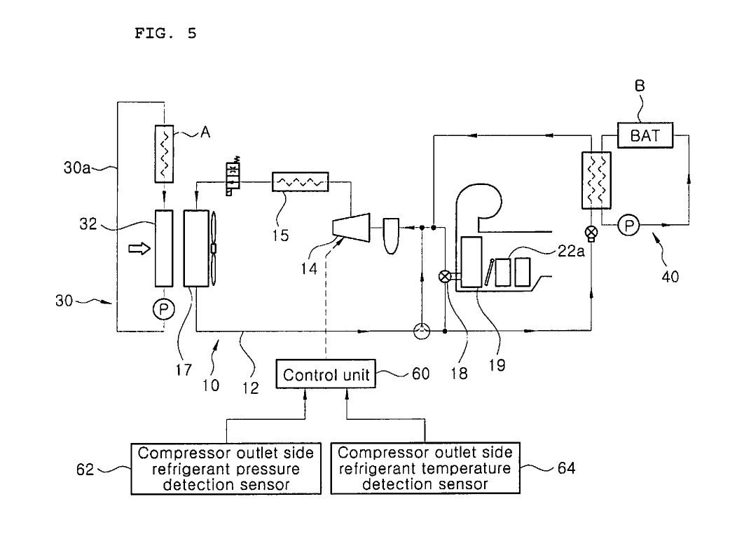

Next, a vehicular air conditioning system according to a second embodiment of the present invention will be described with reference to FIG. 5.

The vehicular air conditioning system according to the second embodiment has the same major components as those of the vehicular air conditioning system according to the first embodiment. Specifically, the refrigerant pressure and the refrigerant temperature on the outlet side of the compressor 14 are detected by the compressor outlet side refrigerant pressure detection sensor 62 and the compressor outlet side refrigerant temperature detection sensor 64. Based on the data thus obtained, the control unit 60 variably controls the rotation speed of the compressor 14.

Unlike the vehicular air conditioning system of the first embodiment that uses the engine 50 as a power source, the vehicular air conditioning system of the second embodiment may be applied to a vehicle not provided with the engine 50, for example, an electric vehicle or a fuel cell vehicle.

The vehicular air conditioning system of the second embodiment is provided with an electric heater 22a in place of the heater core 22 of the first embodiment (see FIG. 1) in which the waste heat of the engine cooling water is used as a main heat source of a passenger compartment. The electric heater 22a is configured to heat the passenger compartment while being operated by the electricity supplied from the battery B.

According to the vehicular air conditioning system of the present invention having such a configuration, when the rotation speed of the compressor is excessive, the rotation speed of the compressor is controlled step by step until the refrigerant discharge pressure and the refrigerant discharge temperature of the compressor 14 become stable. Therefore, it is possible to prevent an excessive increase in the refrigerant discharge pressure and the refrigerant discharge temperature of the compressor 14, which may be caused by the excessively high rotation speed of the compressor 14.

Furthermore, it is possible to prevent degradation, damage or breakage of the compressor, the refrigerant pipes, the sealing components and the like, which may be caused by the excessive increase in the rotation speed of the compressor 14.

Moreover, it is possible to improve the durability of the air conditioning system.

In addition, when the rotation speed of the compressor is excessively lowered, the rotation speed of the compressor 14 is increased to an optimum level. Therefore, it is possible to prevent an excessive increase in the rotation speed of the compressor 14 without deteriorating the passenger compartment cooling performance. This makes it possible to prevent degradation, damage or breakage of the compressor 14, the refrigerant pipes, the sealing components and the like without deteriorating the passenger compartment cooling performance.

Moreover, when the rotation speed of the compressor 14 is increased due to the operation of the water-cooled battery cooling device 40 using the refrigerant of the vehicular air conditioning system 10, the rotation speed of the compressor 14 is controlled step by step until the refrigerant discharge pressure and the refrigerant discharge temperature of the compressor 14 become stable. Therefore, despite the operation of the water-cooled battery cooling device 40, it is possible to prevent an excessive increase in the rotation speed of the compressor 14 and to improve the durability of the compressor 14 regardless of the operation of the water-cooled battery s cooling device 40.

While the preferred embodiments of the present invention have been described above, the present invention is not limited to the above-described embodiments. Various modifications and changes may be made without departing from the scope and spirit of the present invention defined in the claims.

What is claimed is:

1. A vehicular air conditioning system, comprising:
a refrigerant circulation line provided with a compressor, an outdoor heat exchanger, an expansion valve and an indoor heat exchanger; and
a control unit configured to variably control a rotation speed of the compressor depending on a refrigerant discharge pressure and a refrigerant discharge temperature on an outlet side of the compressor.

2. The system of claim 1, wherein the control unit is configured to reduce the rotation speed of the compressor step by step just as much as a predetermined rotation speed value until the refrigerant discharge pressure is increased to a predetermined reference pressure or until the refrigerant discharge temperature is increased to a predetermined reference temperature.

3. The system of claim 2, wherein the control unit is configured to turn off the compressor when the refrigerant discharge pressure reaches the predetermined reference pressure or when the refrigerant discharge temperature reaches the predetermined reference temperature.

4. The system of claim 3, wherein the control unit is configured to primarily reduce the rotation speed of the compressor just as much as a predetermined rotation speed value when the refrigerant discharge pressure is equal to or higher than a predetermined first reference pressure or when the refrigerant discharge temperature is equal to or higher than a predetermined first reference temperature,
the control unit is configured to secondarily reduce the rotation speed of the compressor just as much as a predetermined rotation speed value when the refrigerant discharge pressure becomes equal to or higher than a second reference pressure which is higher than the first reference pressure or when the refrigerant discharge temperature becomes equal to or higher than a second reference temperature which is higher than the first reference temperature, and
the control unit is configured to turn off the compressor when the refrigerant discharge pressure becomes equal to or higher than a third reference pressure which is higher than the second reference pressure or when the refrigerant discharge temperature becomes equal to or higher than a third reference temperature which is higher than the second reference temperature.

5. The system of claim 4, wherein the control unit is configured to maintain the rotation speed of the compressor as it is when at least one of a condition that the refrigerant discharge pressure is lower than the first reference pressure and a condition that the refrigerant discharge temperature is lower than the first reference temperature is satisfied and when both a condition that the refrigerant discharge pressure is equal to or higher than a fourth reference pressure which is lower than the first reference pressure and a condition that the refrigerant discharge temperature is equal to or higher than a fourth reference temperature which is lower than the first reference temperature are satisfied.

6. The system of claim 5, wherein the control unit is configured to increase the rotation speed of the compressor just as much as a predetermined rotation speed value when the refrigerant discharge pressure is equal to or lower than a fifth reference pressure which is lower than the fourth reference pressure or when the refrigerant discharge temperature is equal to or lower than a fifth reference temperature which is lower than the fourth reference temperature.

7. The system of claim 1, further comprising:
a compressor outlet side refrigerant pressure detection sensor configured to detect the refrigerant discharge pressure on the outlet side of the compressor; and
a compressor outlet side refrigerant temperature detection sensor configured to detect the refrigerant discharge temperature on the outlet side of the compressor,
wherein the compressor outlet side refrigerant pressure detection sensor and the compressor outlet side refrigerant temperature detection sensor are installed on the outlet side of the compressor.

8. The system of claim 7, further comprising:
a water-cooled heat exchanger configured to radiate heat of a refrigerant discharged from the compressor; and
a heater core side cooling water circulation line configured to allow cooling water to circulate between the water-cooled heat exchanger and a heater core to heat a passenger compartment with the heat of the refrigerant discharged from the compressor,
wherein the compressor outlet side refrigerant pressure detection sensor and the compressor outlet side refrigerant temperature detection sensor are installed between the outlet side of the compressor and the water-cooled heat exchanger.

9. The system of claim 1, further comprising:
a water-cooled battery cooling device configured to cool a battery using a refrigerant in the refrigerant circulation line,
wherein the control unit is configured to prevent an excessive increase in the rotation speed of the compressor by variably controlling the rotation speed of the compressor depending on the refrigerant discharge pressure and the refrigerant discharge temperature when a load of the compressor is increased due to an operation of the water-cooled battery cooling device.

10. The system of claim 1, further comprising:
a water-cooled electric component module cooling device configured to allow cooling water to circulate between an electric component module and a radiator to cool the electric component module,
wherein the radiator is installed on an upstream side of the outdoor heat exchanger in a flow direction of an air.
